(19) United States
(12) Patent Application Publication
(10) Pub. No.: US 2004/0203410 A1
(43) Pub. Date: Oct. 14, 2004

(54) Golf course wireless network

(76) Inventor: Frederick D. Kim, Sunnyvale, CA (US)

Correspondence Address: FREDERICK KIM, 1372 WARNER AVE., SUNNYVALE, CA, 94087, US

(21) Appl. No.: 10/269,466

(22) Filed: Oct. 11, 2002

(51) Int. Cl. H04B 7/00

(52) U.S. Cl. 455/66.1; 455/344; 455/414.1

(57) ABSTRACT

A golf course wireless network including a plurality of remote computers located on different holes of the golf course is configured as a wireless peer-to-peer network. A signal receiver is connected to each of the remote computers and outputs data to the remote computer. The remote computer transmits the output data to the central computer directly, but if the central computer is out of range, it transmit the output data to another one of the remote computers, which relay the output data to the central computer.

### RELATED APPLICATION

This application is a continuation-in-part of Application Ser. No. [to be assigned], filed Sep. 27, 2002, entitled “Golf Course Speed of Play Monitoring System and Method.”

### BACKGROUND OF THE INVENTION

1. Field of the Invention

The invention relates generally to a wireless network, and more particularly to a golf course wireless network and a system and method that employs the golf course wireless network to monitor speed of play.

2. Description of the Related Art

There are thousands of golf courses in the United States. Even within one metropolitan area, there may be well over one hundred golf courses available to a golfer. A golfer chooses to play a particular golf course for a variety of reasons. These reasons include accessibility, because a golfer cannot play on most private golf courses without a membership or a member accompanying him. Another reason is price. Some golf courses charge in excess of $200 for a round of golf. However, a golfer may choose to pay a high price for a round of golf if the course has a good reputation, is a popular stop on one of the pro golf tours, is maintained very well, is located in a beautiful setting, is a historical landmark, is a tourist attraction, or for some intangible reason.

Other than price, the most practical reason for a golfer choosing a golf course is probably proximity to his or her home, or place of lodging if the golfer is away on a vacation or visiting someone. A golf course which is 10 minutes away will look more attractive than one that is an hour away, especially because a round of golf generally takes anywhere from 4 to 6 hours to play. Thus, when the time to commute to the golf course is added to the playing time, a substantial part of the day must be allocated to golf and the golfer, to a certain extent, forgo other interests, e.g., spending time with his or her family.

Inevitably, because a large block of time is dedicated to golf, the golfer is faced with a choice of playing the sport less frequently or playing the sport at the expense of his other interests. At any rate, even if the golfer chose to devote every hour to golf, the golfer's frequency of play will be reduced if too much time is wasted commuting to the golf course.

Another factor that determines how much time the golfer must block out to play a round of golf is the speed of play. The faster the golfer can finish a round of golf, the sooner the golfer can direct his energy to other interests, or to the avid golfer, the more rounds of golf the golfer can fit into a single day. However, to date, there has been no system for informing the golfer of the speed of play of a particular golf course so that the golfer can evaluate whether or not it would be desirable to play that particular course in view of certain time constraints. Other information such as the greens fee, golf course accessibility as to whether it is public, semi-private, or private, the general layout of the golf course, the length of the golf course, the designer of the golf course, the difficulty of the golf course, the location of the golf course, tee time reservation information, and so forth have been available.

Speed of play is important to a golfer for another reason. It affects the golfer's enjoyment of the sport. Athletes talk about rhythm, and, on a golf course where pace of play is slow, the golfer's rhythm is affected and often leads to degradation in performance. It also affects safety and camaraderie. When the pace of play is slow, a golfer is more likely to be impatient and hit into the group in front, thereby endangering the members of the group in front. Such behavior often leads to heated arguments, sometines fights, and degrades the sport itself.

Slow play is also hazardous to the golfer's health. During hot summer months, slow play exposes golfers to the sun for longer periods of time, exposing the golfer to possible dehydration and heat stroke, and to ultraviolet rays that may cause sunburn and worse yet skin cancer.

### SUMMARY OF THE INVENTION

An object of the invention is to provide a golf course wireless network. The wireless network according to the system includes a plurality of computers connected together over a wireless peer-to-peer network. The computers may be installed at fixed locations, e.g., near the greens or on golf carts, and are connected to wireless data links that enable the peer-to-peer wireless communication.

Another object of the invention is to provide a system and method that employs the golf course wireless network to monitor speed of play. The monitoring system according to the invention has transmitters mounted in each of the flag sticks on a golf course. The transmitters issue a signal each time they are returned to their respective holding cup, or in the alternative, each time they are taken out of their respective holding cup. The transmitted signal may be directly transmitted to a central unit that processes the transmitted signals to determine the speed of play or relayed to such a central unit over a wireless network.

The monitoring system does not require any specialized inputs from the user and can monitor the flow of play on the golf course without being dependent on any actions by the golfer that is unrelated to the game of golf. It is able to monitor the flow of play based on signals generated as a result of natural actions of a golfer playing a round of golf.

For example, the system relies on the removal of the flag from its holding cup and repositioning of the flag therein. This act, although performed affirmatively by the golfer or his caddy, is part of the game. If the golfer does not remove the flag from its holding cup while he or she is on the green and in the act of putting, according to the rules of golf, the golfer is assessed a two-stroke penalty if the putted ball hits the flag.

The monitoring system according to the invention may be implemented with passive detectors (e.g., motion detectors, noise detectors, heat detectors, etc.) located around the greens, or in the alternative, tee boxes. The detector is connected to a transmitter and, when the detector goes active, the transmitter issues a signal. The transmitted signal is transmitted to a central unit that processes the transmitted signals to determine the speed of play. This system also does not require any specialized inputs from the user and is able to monitor the flow of play based on signals generated as a result of natural actions of a golfer playing a round of golf.

Additional objects, features and advantages of the invention will be set forth in the description of preferred embodiments which follows.

### BRIEF DESCRIPTION OF THE DRAWINGS

The invention is described in detail herein with reference to the drawings in which:

FIG. 1A is a schematic illustration of the monitoring system according to a first embodiment of the invention;

FIG. 1B is a schematic illustration of the monitoring system according to a second embodiment of the invention;

FIG. 2A is a schematic illustration of a remote transmitter section used in the system of FIG. 1A;

FIG. 2B is a timing diagram of the signals produced by the remote transmitter section of FIG. 2A;

FIG. 3A is a schematic illustration of another type of remote transmitter section used in the system of FIG. 1A;

FIG. 3B is a timing diagram of the signals produced by the remote transmitter section of FIG. 3A;

FIG. 4 is an illustration of a flag stick having the remote transmitter section;

FIG. 5 is a representative flow diagram of a computer program collecting the flow of play information for one hole based on the signals produced by the signal transmitter of that one hole;

FIG. 6 is a flow diagram of a computer program for displaying the flow of play information;

FIG. 7 is a sample display of the flow of play information;

FIG. 8 is an illustration of a flag stick having a remote transmitter section of another type;

FIG. 9 is an exploded view of the remote transmitter section shown in FIG. 8;

FIG. 10A is an illustration of a first embodiment of the wireless network according to the invention;

FIG. 10B is an illustration of a second embodiment of the wireless network according to the invention;

FIG. 11 illustrates a process for setting up the wireless network according to the invention; and

FIGS. 12-15 are flow diagrams of computer programs for transmitting information from remote locations to a base station.

The accompanying drawings, which are incorporated in and constitute a part of the specification, illustrate presently preferred exemplary embodiments of the invention, and, together with the general description given above and the detailed description of the preferred embodiments given below, serve to explain the principles of the invention.

### DETAILED DESCRIPTION OF THE PREFERRED EMBODIMENT

In the following description, the term “speed of play” is defined as the amount of time it takes to play a round of golf, a round of golf typically being 18 holes. Also, the term “hole” is defined to generally refer to and include the area between the tee box and the green, and is not limited to the cup where the physical hole lies.

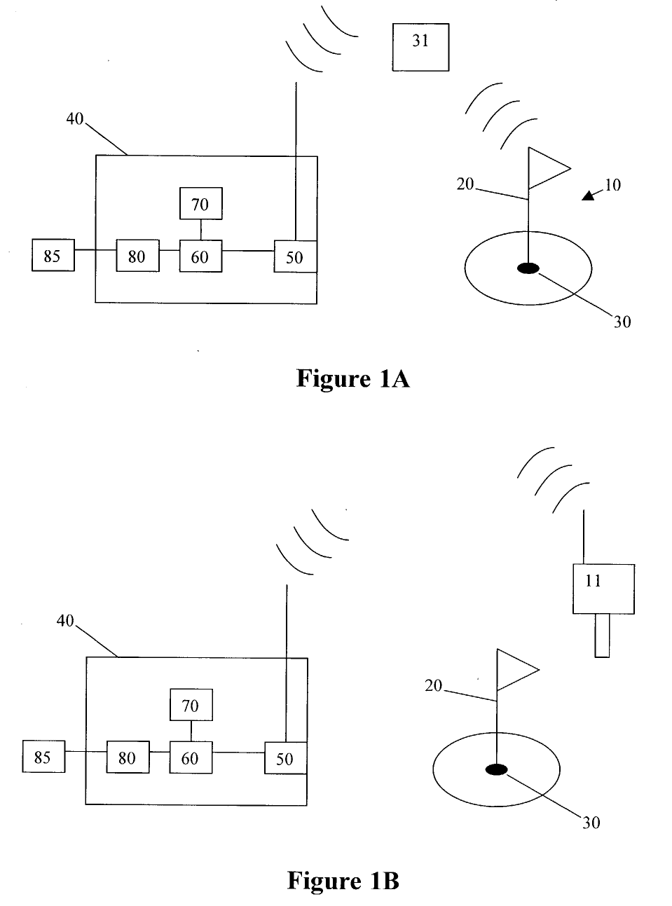

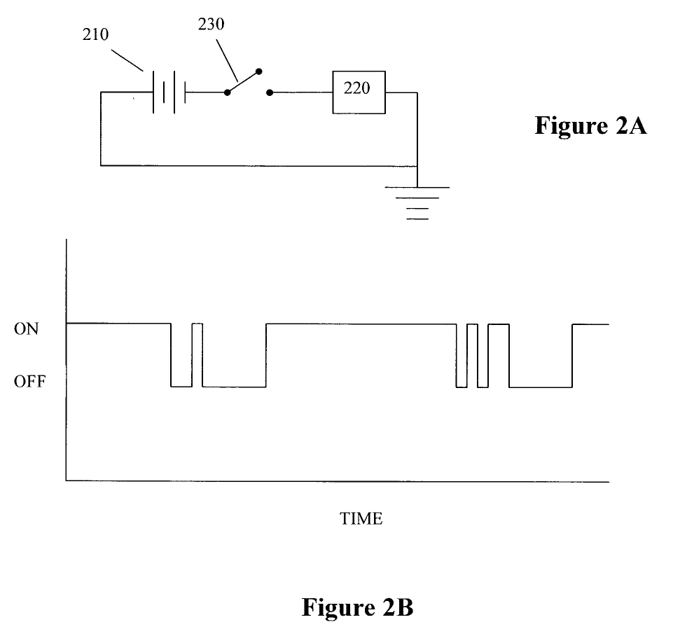

FIG. 1A illustrates the flow of play monitoring system according to a first embodiment of the invention. The flow of play monitoring system according to this embodiment includes a plurality of remote transmitter sections 10 (which is described in more detail below with reference to FIGS. 2A, 2B, 3A, 3B, 4, 8, and 9), only one of which is illustrated in FIG. 1A, and a host unit 40 comprising a receiver 50, a CPU 60, a memory 70, and an I/O interface 80. The number of remote transmitter sections 10 equal the number of holes on a particular golf course. For example, if the golf course is a nine-hole golf course there are nine remote transmitter sections 10. On the other hand, if the golf course is an eighteen-hole golf course, which is more typical, there are eighteen remote transmitter sections. In the following description, it is assumed that the golf course for which flow of play is monitored has eighteen holes.

When a golfing group finishes playing out a hole and a flag stick 20 is replaced in its holding cup 30, an encoded signal is transmitted. The system may be alternatively designed so that the encoded signal is transmitted when the flag stick 20 is removed from the holding cup 30. The encoded signal is received and decoded at the receiver 50 and processed by the CPU 60 to generate flow of play data for the golf course. The flow of play data is then stored in the memory 70 and transmitted through the I/O interface 80 to a display 85.

An optional signal transceiver 31 is illustrated in FIG. 1A. The signal transceiver 31 is a signal receiver-transmitter combination located in close proximity to the remote transmitter section 10 (e.g., near the green where the flag stick 20 is located) and is used if the remote transmitter section 10 is designed for short range transmission (i.e., a few hundred feet as opposed to a few miles for long range transmission). By using the signal transceiver 31, the size of the battery used in the remote transmitter section 10 can be minimized.

The signal transceiver 31 may be connected to a permanent power source (e.g., power line). When connected to a permanent power source, the signal is transmitted via the power line. The AN48 Family chipsets produced by Adaptive Networks having a range of up to 50 km may be used to transmit and receive the signals over the power line.

If a permanent power source is not readily available, the signal is transmitted wirelessly, either by RF (using spread spectrum techniques) or by Cellemetry™, which is means of wireless data communications that taps the unused capacity of the cellular telephone network's overhead control channels and the SS7/IS-41 network protocol to deliver short data messages without affecting the voice channels of the cellular network.

FIG. 1B illustrates the flow of play monitoring system according to a second embodiment of the invention. The flow of play monitoring system according this embodiment includes a plurality of remote transmitter sections 11, only one of which is illustrated in FIG. 1B, and a host unit 40 comprising a receiver 50, a CPU 60, a memory 70, and an I/O interface 80. The number of remote transmitter sections 10 equal the number of holes on a particular golf course.

In this embodiment, the remote transmitter section 11 is located in close proximity (about 40-80 feet) to the flag stick 20 and includes a motion detector (or a noise detector) that initiates signal transmission when motion (or noise) is detected thereby. For example, when a golfing group approaches the flag stick 20, the motion detector located in close proximity thereto causes an encoded signal to be transmitted by the remote transmitter section 11. When this golfing group leaves, the signal transmission ceases. The encoded signal is received and decoded at the receiver 50 and processed by the CPU 60 to generate flow of play data for the golf course. The flow of play data is then stored in the memory 70 and transmitted through the I/O interface 80 to a display 85.

The signal transceiver 31 may be connected to a permanent power source (e.g., power line). When connected to a permanent power source, the signal is transmitted via the power line. The AN48 Family chipsets produced by Adaptive Networks having a range of up to 50 km may be used to transmit and receive the signals over the power line.

If a permanent power source is not readily available, the signal is transmitted wirelessly, either by RF (using spread spectrum techniques) or by Cellemetry™, which is means of wireless data communications that taps the unused capacity of the cellular telephone network's overhead control channels and the SS7/IS-41 network protocol to deliver short data messages without affecting the voice channels of the cellular network.

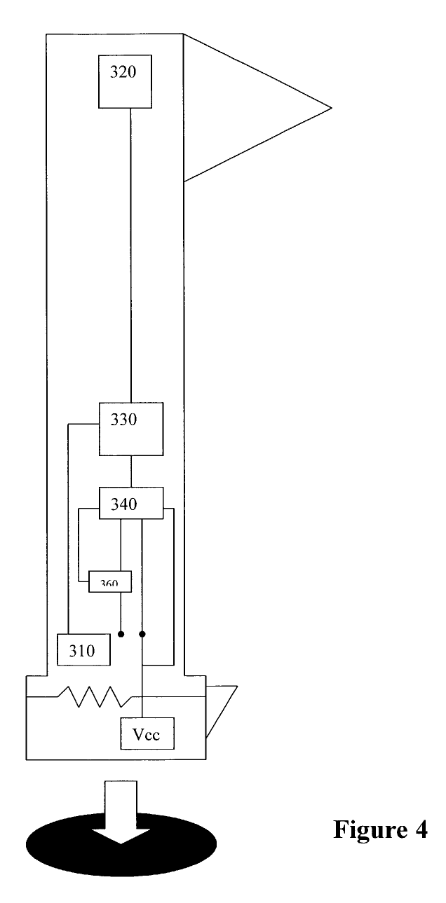

FIG. 2A schematically illustrates a remote transmitter section 10 in more detail. The remote transmitter section 10 includes a power source 210 connected to a transmitter 220 through a switch 230. The switch 230 may be a mechanical switch, a capacitance switch, a magnet-actuated switch, an accelerometer switch, a tilt switch that senses when an object has been positioned beyond a certain inclination angle, or any other types of switch generally employed in the electronics art. The structure of the switch used in the exemplary embodiment will be described with reference to FIG. 4.

When the flag stick 20 is placed in its holding cup 30, the switch 230 closes and the transmitter 220 is activated to continuously issue an encoded signal until the flag stick 20 is removed from its holding cup 30 and the switch 230 returns to its open position. FIG. 2B illustrates the timing diagram of the encoded signals produced by the remote transmitter 220. The ON level corresponds to a state where the flag stick 20 is placed in its holding cup 30 and the remote transmitter 220 is thereby transmitting an encoded signal. The OFF level corresponds to a state where the flag stick 20 is removed from its holding cup 30 and the remote transmitter 220 is thereby transmitting no signal.

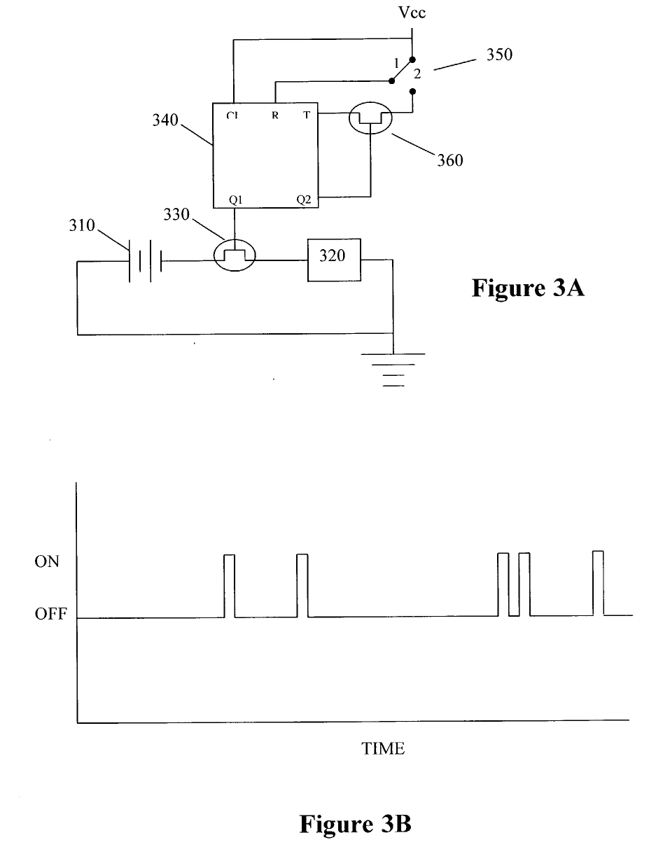

FIG. 3A schematically illustrates another type of remote transmitter section 10. With this type, the remote transmitter section 10 includes a power source 310 connected to a transmitter 320 through a transistor switch 330. The transistor switch 330 is controlled by an output signal from a timer 340 having a clock terminal (CL), a reset terminal (R), a trigger input terminal (TR), and two output terminals (Q1 and Q2). The first output terminal (Q1) is connected to the gate of the transistor switch 330. When the first output terminal (Q1) issues a high signal, the transistor switch 330 is turned ON to connect the power source 310 to the transmitter 320. Otherwise, the transmitter 320 remains disconnected from the power source 310.

The trigger input terminal (TR) of the timer 340 is connected to a power source Vcc through a pair of switches, a switch 350 which may be a mechanical switch, a capacitance switch, a magnet-actuated switch, a tilt switch or any other types of switch generally employed in the electronics art and a transistor switch 360. The transistor switch 360 has a reversed polarity as compared to the transistor switch 330. Therefore, the transistor switch 360 is normally ON and when a high signal is applied to its gate, it is turned OFF. The structure of the switch 350 will be described with reference to FIG. 4. The switch 350 is different from the switch 230 in that the switch 350 has two active positions—Positions 1 and 2.

In Position 1, the switch 350 connects the power source Vcc to the reset terminal (R) of the timer 340. This connection resets the timer 340 so that is counter is made to be zero. In Position 2, the switch 350 connects the power source Vcc to the trigger terminal (TR) of the timer 340 to cause the first output terminal (Q1) to issue a high signal. However, when the timer 340 reaches its maximum count, its second output terminal (Q2) goes to a high level and causes the transistor switch 360 to be non-conductive since the second output terminal (Q2) of the timer 340 is connected to the gate of the transistor switch 360.

When the flag stick 20 is placed in its holding cup 30, the switch 350 moves into Position 2 and the timer 340 is triggered to generate a high output for a predetermined number of clock cycles. As a result, the transistor switch 330 is made conductive to connect the power source 310 and the transmitter 320 and to cause the transmitter 320 to issue an encoded signal for the predetermined number of clock cycles. The predetermined number of clock cycles is chosen such that an encoded signal of a sufficient length is transmitted by the transmitter 320 for receipt and decoding by the receiver 50. When the timer 340 expires, i.e., the timer 340 has reached its maximum count, the second output terminal (Q2) of the timer 340 issues a high signal to cause the transistor switch 360 to be non-conductive and disconnect the power source Vcc from the trigger input (TR) of the timer 340. Consequently, a low signal is issued from the first output (Q1) of the timer 340 to disconnect the power source 310 from the transmitter 320. As a result, the transmitter 320 stops transmitting. FIG. 3B illustrates the timing diagram of the encoded signals produced by the remote transmitter 320. The ON level corresponds to a state wherein the flag stick 20 is placed in its holding cup 30 and the remote transmitter 320 transmits an encoded signal. The OFF level corresponds to a state wherein the flag stick 20 is removed from its holding cup 30 and the remote transmitter 320 transmits no signal.

FIG. 4 is an illustration of a flag stick 20 having the remote transmitter section 10. The flag stick 20 is shown with a corresponding holding cup 30 and a spring-biased movable lever 25. When the flag stick 20 is placed in the holding cup 30, the movable lever 25 slides inwards against the force of its bias spring. When the flag stick 20 is removed from the holding cup 30, the movable lever 25 slides out by the force of its bias spring.

When the remote transmitter section 10 of FIGS. 2A and 2B is used, the switch 230 is connected to the movable lever 25 to be movable therewith. When the movable lever 25 is in its relaxed, outward position, the switch 230 is in its open position. When the movable lever 25 is in its compressed, inward position, the switch 230 is in its closed position.

When the remote transmitter section 10 of FIGS. 3A and 3B is used, the switch 350 is connected to the movable lever 25 to be movable therewith. When the movable lever 25 is in its relaxed, outward position, the switch 350 is in Position 1. When the movable lever 25 is in its compressed, inward position, the switch 350 is in Position 2.

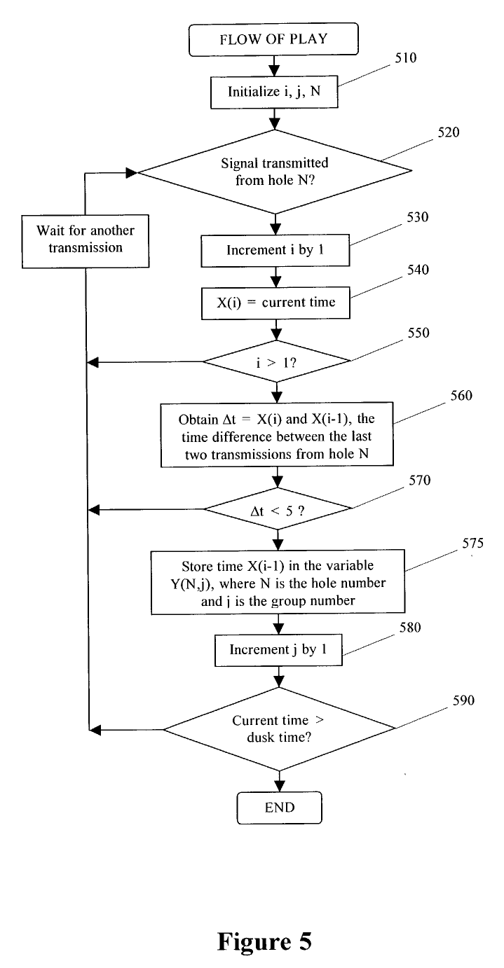

Referring to FIG. 5, a representative flow diagram of a computer program FLOW OF PLAY which collects the flow of play information for one hole based on the signals produced by the remote transmitter section 10 of that one hole will be described. The flow of play information for other holes is collected in a similar manner.

In Step 510, N is initialized with the hole number. For example, if hole number 1 is being processed, N=1. Also, i is initialized with the value of 0 and j, the group number, is initialized with the value of 1. Step 520 checks to see if a signal is received from the transmitter section 10 of hole number N until the signal is received. When it is received, the flow proceeds to Step 530, where i is incremented by 1. In Step 540, the variable X(i) is assigned a value equal to the current time, t. For example, if the current time is 1:00 p.m., X(i) is assigned 13:00 as its value. Step 550 checks to see if i is greater than 1. If not, flow returns to Step 520. If i is greater than 1, then flow proceeds to Step 560, where the variable Δt is assigned a value equal to the difference of X(i) and X(i−1). Using Step 560, the time difference between the last two transmissions from the transmitter section 10 of hole number N is obtained. If this time difference is less than 5 minutes (Step 570), it is determined that the same group is playing hole number N and the program waits for another transmission by returning to Step 520. On the other hand, if this time difference is greater than or equal to 5 minutes, it is determined that the current transmission is by a different group and that the previous group finished playing this hole at time X(i−1). Therefore, in Step 575, the time X(i−1) is stored in the variable Y(N,j), where N is the hole number and j is the group number. In Step 580, the group number j is incremented by 1. Step 590 checks to see if it is the end of the day, i.e., current time is greater than dusk time. If not, the program returns to Step 520 to await another transmission. If it is dusk, the program ends.

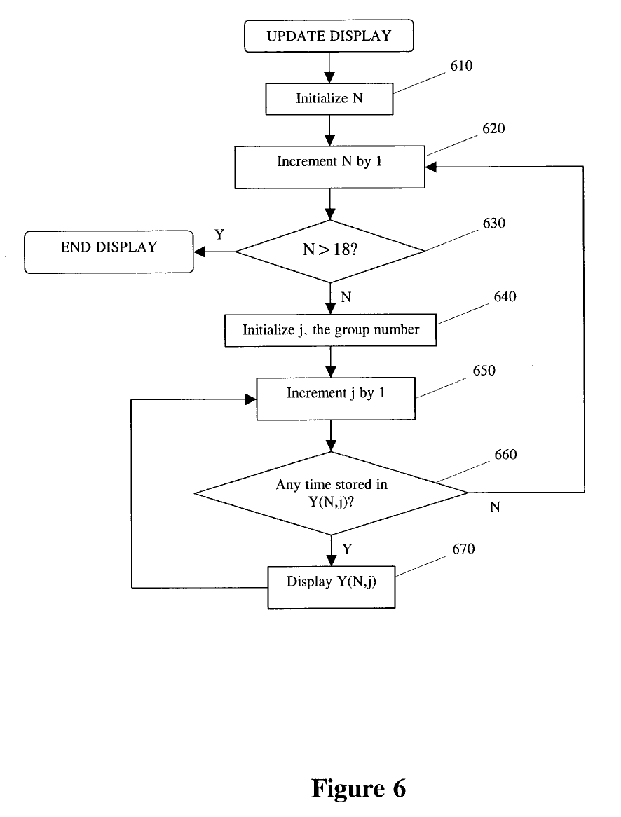

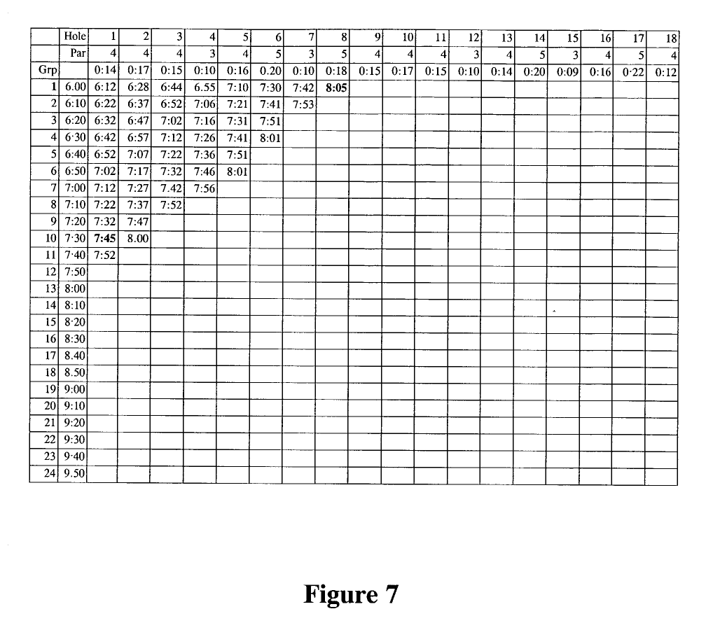

At periodic intervals, e.g., once every minute, an UPDATE DISPLAY routine is executed by the CPU 60 to display the flow of play information. FIG. 6 is a flow diagram of the computer program for displaying the flow of play information. FIG. 7 is a sample display generated by the UPDATE DISPLAY routine. The display may be located centrally at the pro shop where the golf course management can monitor the flow of play. The display may also be made available to golf course rangers who are enforcing speed of play out on the golf course by providing them with portable electronic devices that is capable of such a display or a simpler version of such a display.

In Step 610, the variable N, representing the hole number, is initialized with a value of 0, and in Step 620, N is incremented by 1. Step 630 checks to see if N is greater than 18. If it is, this means that all of the holes have been processed and the UPDATE DISPLAY routine is exited. If N is less than or equal to 18, then flow proceeds to Step 640, where j, representing the group number, is initialized with a value of 0. In Step 650, j is incremented by 1. Step 660 checks to see if there is any time stored in the variable Y(N,j). If not, this means that no time has been collected as of yet for hole number N and group number j and flow returns to Step 620, where the hole number is incremented. If there is time stored in the variable Y(N,j), that time is displayed at cell(N,j), where N is the row number of the display illustrated in FIG. 7 and j is the column number of the display illustrated in FIG. 7. The cell values in FIG. 7 represent the time that a group number j finished playing out a hole number N. After displaying in Step 670, flow returns to Step 650 where the group number is incremented.

The invention may also include have the following additional features.

First, the power source may be a battery that is installed at the base of the flag to serve as a stabilizing weight. The battery may be connected to a low power indicator which causes the remote transmitter to issue a predetermined signal when the battery drains down to a particular level.

Second, the system may also include a speed of play indicator installed at each tee box. The speed of play indicator includes a set of three colored lights—a green light, a yellow light, and a red light. One of the three lights is turned ON a predetermined time after a group has finished playing the previous hole. If it is determined that the group is playing at a fast or normal pace, the green light is lit. If it is determined that the group is playing at a slow pace, one of three things may happen. The yellow light is lit to warn the group that it is playing too slow. If the group has been warned once before, the red light is lit to ask the group to skip its tee shot. If the group was asked to skip its tee shot previously, the red light is caused to flash to ask the group to leave the golf course.

The speed of play indicator is controlled by the CPU 60 based on a program that pinpoints the slow groups on the golf course in accordance with the speed of play information that the CPU 60 is continuously compiling. The CPU makes a comparison of playing time estimates with the actual time incurred by a particular group to determine whether that particular group is behind the preset pace. A transmitter (not shown) is connected to the CPU 60 to provide this information to each of the speed of play indicators and each speed of play indicator is equipped with a matching receiver.

The speed of play indicator may also be controlled by the golf course management that is monitoring the speed of play with the display of FIG. 7. In FIG. 7, any group that is currently behind schedule is indicated by a bold face (e.g., Group 1), and any time a group completes a hole behind schedule, the corresponding time entry is indicated by a bold face (e.g., Group 1, Hole 8 and Group 10, Hole 1).

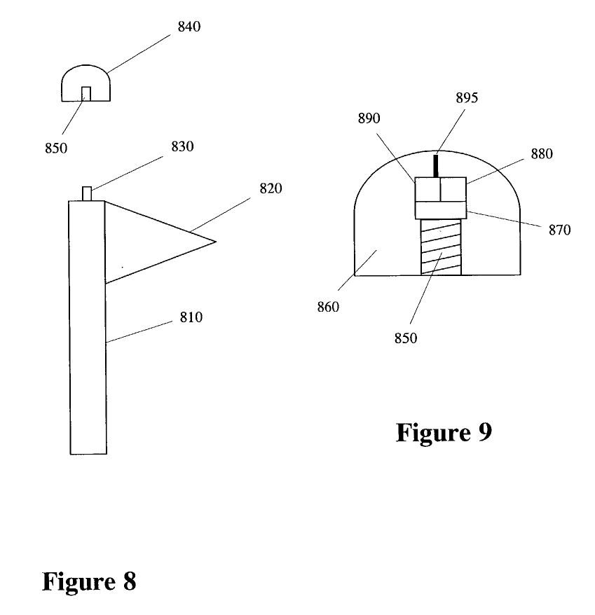

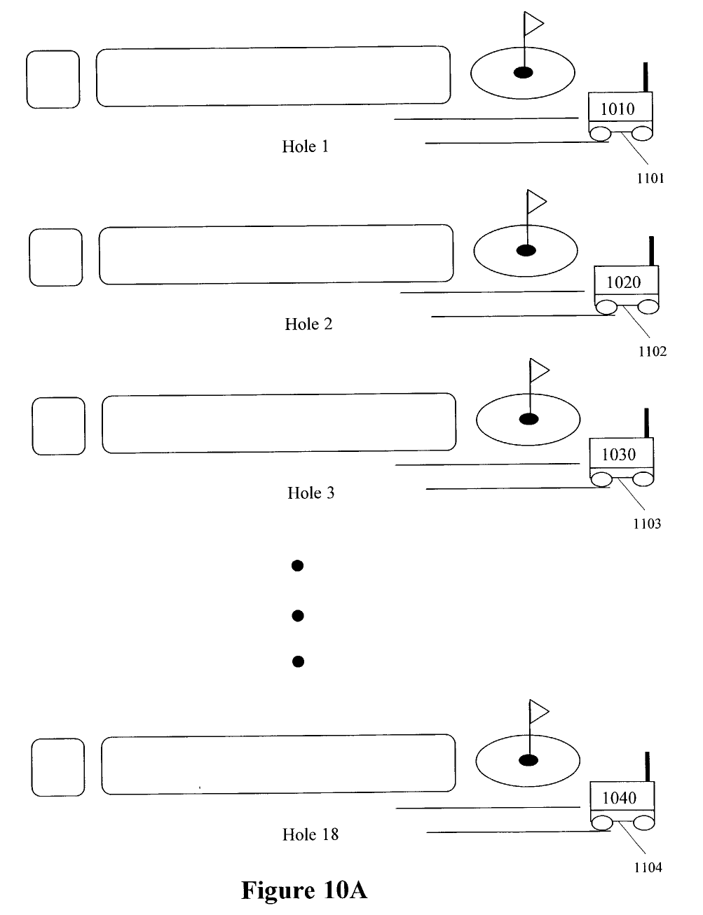

FIG. 8 illustrates the flag stick 20 having a remote transmitter section of another type. This remote transmitter section, designated as 840, has an upper side which is spherical in shape and a bottom side which is flat. The bottom side includes an opening 850 with internal threads (shown in FIG. 9) that mates with (i.e., screws onto) an extension 830 having external threads. The extension 830 is typically used with a corresponding cap to hold the flag 820 in place. The remote transmitter section 840 is intended to replace this cap and will perform a dual function: (i) hold the flag 820 in place and (ii) transmit signals to a receiver.

The remote transmitter section 840 is illustrated in greater detail in FIG. 9. It includes a plastic housing 860, a power source 870, a switch 880, a transmitter 890, and an antenna 895. The power source 870 is preferably a coin cell battery. The switch 880 is preferably an accelerometer switch and is designed to trigger when the flag stick 20 is removed from its holding cup and returned to its holding cup. The transmitter 890 is preferably a TRF4900 RF transmitter chip produced by Texas Instruments and the antenna 895 is selected so that transmission range is about 100-200 feet. The remote transmitter section 840 is intended to be used with a signal transceiver 21 and other components of the monitoring system shown in FIG. 1A.

A typical accelerometer switch has a high quiescent current drain while it is in its active monitoring state. Therefore, as a way to limit the amount of power usage, the switch 880 may be configured instead as a mercury-filled tilt switch that triggers the transmitter 890 in response to up and down accelerations of the flag stick 20.

In high wind conditions, the mercury-filled tilt switch could trigger unwanted transmissions. To prevent unwanted transmissions, the accelerometer switch, which is less likely to trigger unwanted transmissions in high wind conditions, and the tilt switch may be used in combination, with the tilt switch initially triggering the accelerometer into an active monitoring state and the accelerometer switch triggering the transmitter 890 in response to up and down accelerations of the flag stick 20.

The speed of play information can be used by the golf course management to pinpoint those groups who are slowing up play in the above manner. The information may also be used to identify parts of the golf course where play is unreasonably slow, thereby creating a bottleneck of groups at these locations. The golf course management can use this information to identify the sources of delay and take corrective action. For example, it may be determined that the cause of delay may be related to the difficulty of a particular hole. In this instance, the management may want to move up the tee box to make the hole shorter or, if this is not practicable, provide an easier pin placement especially during days when the golf course is crowded.

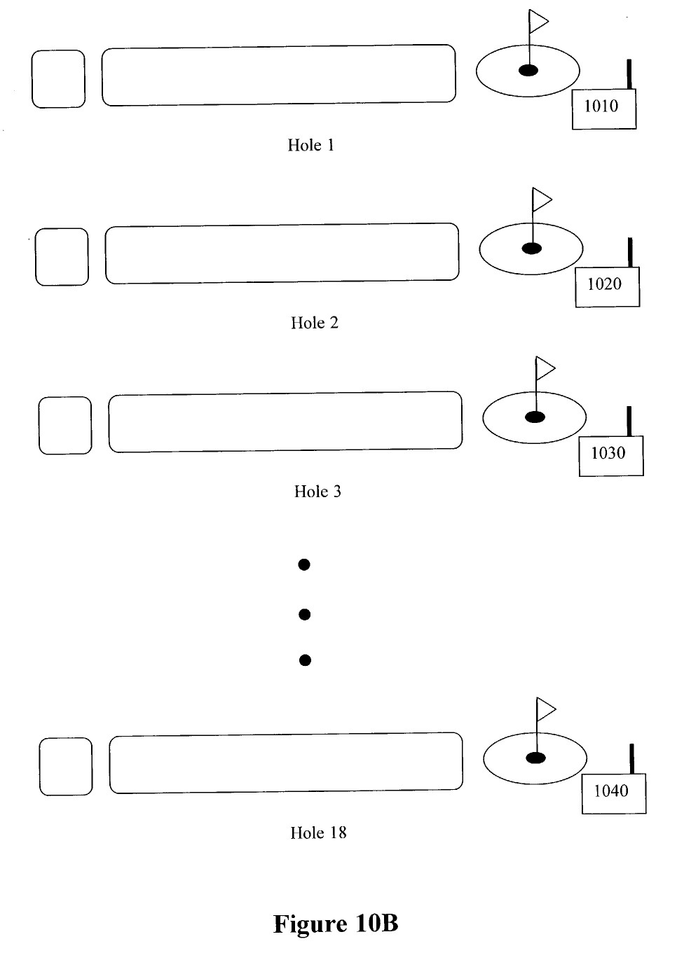

Two embodiments of the wireless network according to the invention are illustrated in FIGS. 10A and 10B. In FIGS. 10A and 10B, only Hole Nos. 1, 2, 3, and 18 are illustrated. Hole Nos. 4-17 are understood to have the same configuration as Hole Nos. 1, 2, 3, and 18.

In FIG. 10A, remote units 1010, 1020, 1030, and 1040 are carried on carts 1101, 1002, 1003, and 1004, respectively. Each remote unit includes a signal receiver, a portable computer (e.g., Pocket PC), and a wireless data link (preferably 2.4 GHz wireless modems, known as 24XStream-PKG, manufactured by MaxStream, Inc. or wireless RS232 data links, known as ConnexLink, manufactured by AeroComm). When the signal receiver on the remote unit senses a transmission issued by the transmitter 890 (see FIG. 9), it outputs the ID of the transmitter 890 (so as to identify the hole) to the portable computer. The portable computer transmits this ID, a corresponding time stamp, and its own identification information to the central computer located at the pro shop through the wireless data link. In FIG. 10B, the remote units 1010, 1020, 1030, and 1040 have a fixed greenside location.

The network connection between the portable computers and the central computer is achieved through the wireless data links. In the invention, the network is configured as a peer-to-peer network, which means that each portable computer is able to send and receive data to and from the central computer and to and from any other portable computer. This network configuration assures that information transmitted back to the central computer reaches the central computer, either directly or indirectly through the other portable computers in the network when the portable computer cannot send the information directly to the central computer because the transmission is blocked by trees, hills, or simply out-of-range.

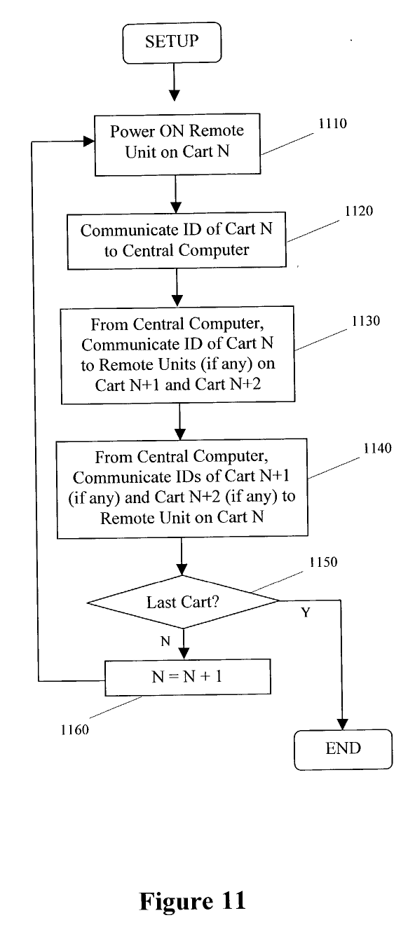

FIG. 11 illustrates a process for setting up the wireless network according to the invention. For the purposes of this description, it is assumed that only one cart in a golfing group has a remote unit (which includes a receiver, portable computer, and a wireless data link) installed thereon, and only carts with remote units have a numbered designation, e.g., N−2, N−1, N, N+1, N+2, etc., where N represents the golfing group associated with the cart, and where N=1 signify the first golfing group of the day, N=2 signify the second golfing group of the day, and so forth.

Each time a remote unit on a cart (e.g., Cart N) is powered ON (Step 1110), e.g., at the beginning of a round near the start of Hole No. 1 in close proximity to the central computer, the portable computer of that cart transmits the cart ID to the central computer (Step 1120). Then, from the central computer, the ID of that cart is transmitted to the portable computers on two carts (e.g., Cart N+1 and Cart N+2) that are in front, if any (Step 1130), and the IDs of Cart N+1 and Cart N+2, if any, are transmitted to the portable computer on Cart N (Step 1140).

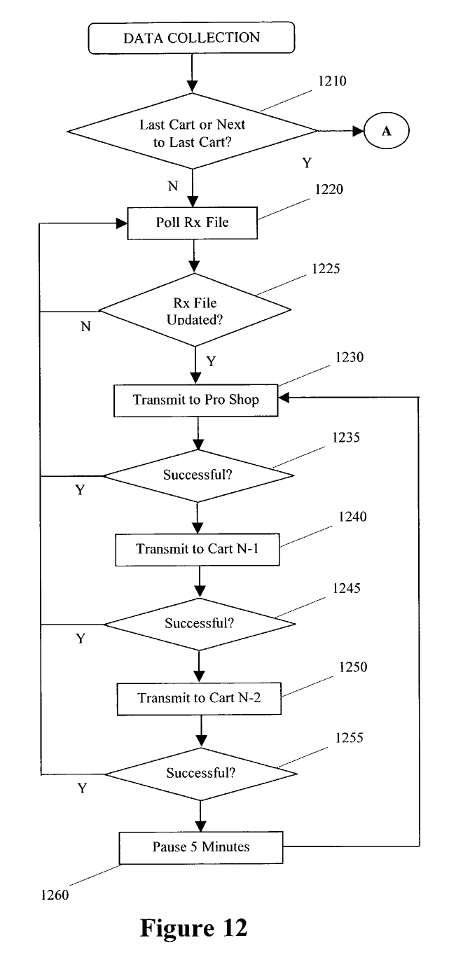

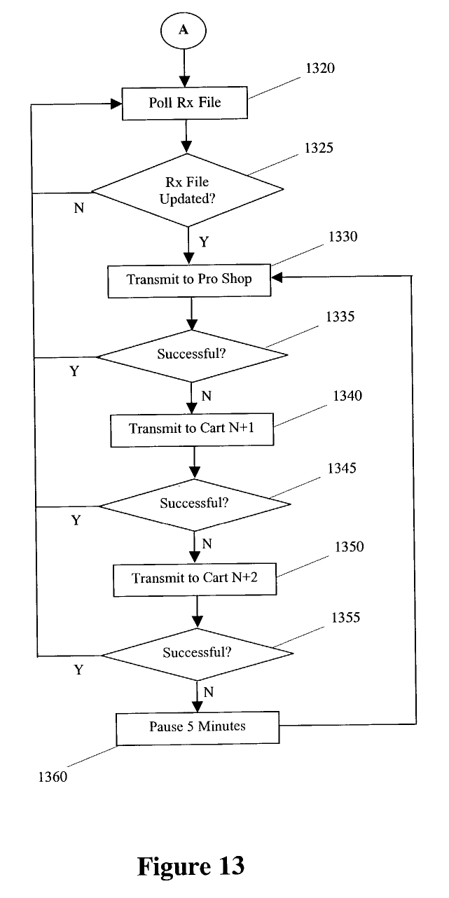

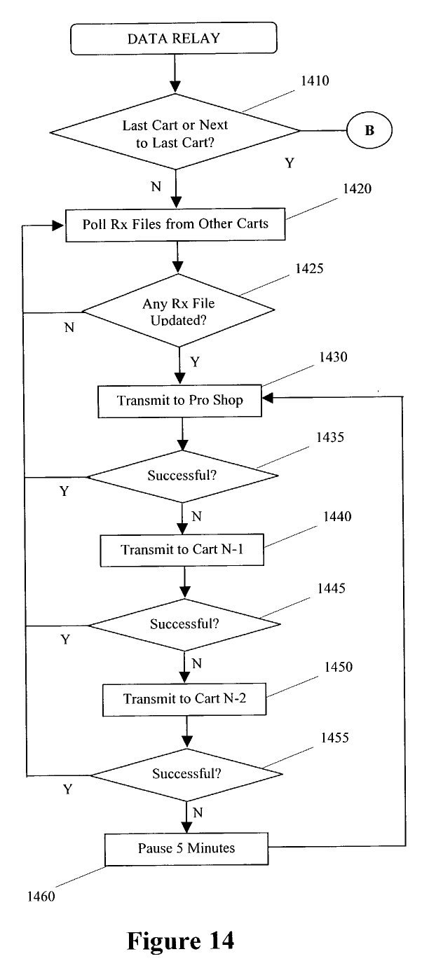

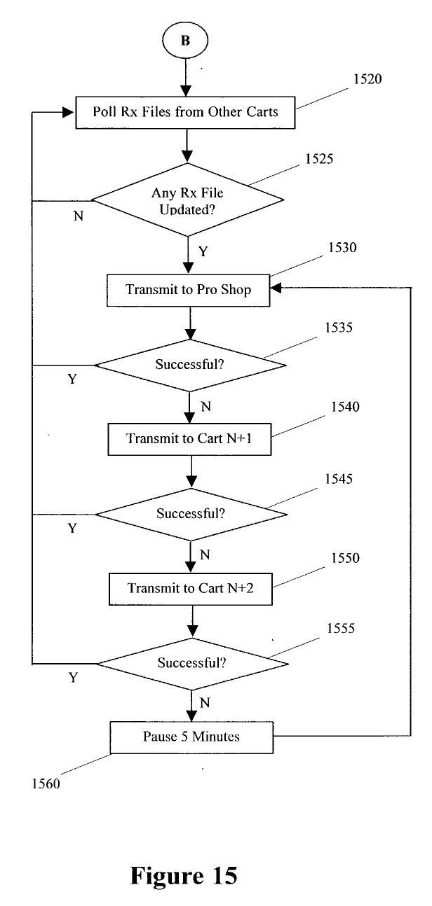

FIGS. 12-15 are flow diagrams of computer programs running on the portable computers of the remote units for transmitting information over the wireless network to the central computer. Computer programs according to flow diagrams of FIGS. 12 and 14 are running on portable computers of carts in all golfing groups except for the carts in the last golfing group and the next-to-last golfing group (see Steps 1210 and 1410). The portable computers on carts in the last golfing group and the next-to-last golfing group have computer programs according to flow diagrams of FIGS. 13 and 15 running thereon.

In FIGS. 12-15, “Rx File” represents the file in the portable computer into which the data collected by the receiver is stored. Each time the receiver outputs new data (e.g., hole number identifier and time stamp), the Rx File is updated to include the new data.

The Rx File is continuously monitored (Steps 1220 and 1320). If an update is detected (Steps 1225 and 1325), it is transmitted to the pro shop (i.e., central computer) (Steps 1230 and 1330). If an acknowledgement of transmission is received from the pro shop, the transmission is deemed successful (Steps 1235 and 1335) and continuous Rx File monitoring is carried out again (Steps 1220 and 1320). If an acknowledgement of transmission is not received from the pro shop, the Rx File is transmitted to the remote unit in an adjacent group (Steps 1240 and 1340). If an acknowledgement of transmission is received from the adjacent group, the transmission is deemed successful (Steps 1245 and 1345) and continuous Rx File monitoring is carried out again (Steps 1220 and 1320). If an acknowledgement of transmission is not received from the adjacent group, the Rx File is transmitted to the remote unit in the next adjacent group (Steps 1250 and 1350). If an acknowledgement of transmission is received from the next adjacent group, the transmission is deemed successful (Steps 1255 and 1355) and continuous Rx File monitoring is carried out again (Steps 1220 and 1320). If an acknowledgement of transmission is not received from the next adjacent group, the computer program waits five minutes (Steps 1260 and 1360) and tries again to make a successful transmission to the pro shop, adjacent group, and the next adjacent group.

The Rx File that is received from another group is also continuously monitored (Steps 1420 and 1520). If an update is detected (Steps 1425 and 1525), it is transmitted to the pro shop (i.e., central computer) (Steps 1430 and 1530). If an acknowledgement of transmission is received from the pro shop, the transmission is deemed successful (Steps 1435 and 1535) and continuous Rx File monitoring is carried out again (Steps 1420 and 1520). If an acknowledgement of transmission is not received from the pro shop, the Rx File is transmitted to the remote unit in an adjacent group (Steps 1440 and 1540). If an acknowledgement of transmission is received from the adjacent group, the transmission is deemed successful (Steps 1445 and 1545) and continuous Rx File monitoring is carried out again (Steps 1420 and 1520). If an acknowledgement of transmission is not received from the adjacent group, the Rx File is transmitted to the remote unit in the next adjacent group (Steps 1450 and 1550). If an acknowledgement of transmission is received from the next adjacent group, the transmission is deemed successful (Steps 1455 and 1555) and continuous Rx File monitoring is carried out again (Steps 1420 and 1520). If an acknowledgement of transmission is not received from the next adjacent group, the computer program waits five minutes (Steps 1460 and 1560) and tries again to make a successful transmission to the pro shop, adjacent group, and the next adjacent group.

In the embodiment of FIG. 10B where the remote units are located greenside instead of on carts, each of the remote units is tested upon installation to determine if its signals are received at the central computer with sufficient strength. If not, a remote unit that is closer to the central computer and from which signals of sufficient strength are received at the central computer, is selected as the remote unit for relaying the Rx file of the “out-of-range” remote unit.

If, for example, it is determined that remote units located greenside at hole numbers 1-2, 7-11, and 16-18 are within range of the central computer, these remote units will be configured to communicate directly with the central computer. Each of the other “out-of-range” remote units is configured to communicate with a relay remote unit. The relay remote unit is typically one of the remote units that are within range of the central computer, and the relay remote unit is configured to relay the Rx file received from the “out-of-range” remote unit to the central computer. For example, the remote units at hole numbers 3-6 may be configured to employ the remote unit located greenside at hole number 7 as their relay remote unit and the remote units at hole numbers 12-15 are configured to employ the remote unit located greenside at hole number 16 as their relay remote unit.

The assignment of remote units for direct communication with the central computer and the assignment of the relay remote units to be used by the other remote units are dependent on the layout of the golf course, in particular the hole locations with respect to the location of the central computer, and in certain situations, an “out-of-range” remote unit may require more than one relay remote unit to communicate with the central computer. For example, if the remote unit at hole number 5 is out of range of all of the remote units that are in range of the central computer, the remote unit at hole number 5 would be configured to communicate with one of the other “out-of-range” remote unit and relay its Rx file to the central computer through this “out-of-range” remote unit and the relay remote unit assigned to this “out-of-range” remote unit.

While particular embodiments according to the invention have been illustrated and described above, it will be clear that the invention can take a variety of forms and embodiments within the scope of the appended claims.

I claim:

1. A golf course wireless network, comprising:
a central computer;
a plurality of remote computers located on different holes of the golf course, said central computer and remote computers forming a wireless peer-to-peer network; and
a signal receiver connected to one of the remote computers and outputting data to said one of the remote computers,
wherein said one of the remote computers is programmed to transmit said data to said central computer if the central computer is in range and to another one of the remote computers if the central computer is out of range.

2. The golf course wireless network as recited in claim 1, wherein the signal receiver outputs said data in response to a transmission received thereat and said data includes hole location data and time stamp data.

3. The golf course wireless network as recited in claim 1, wherein said another one of the remote computers is programmed to transmit said data to said central computer if the central computer is in range and to another one of the remote computers if the central computer is out of range.

4. The golf course wireless network as recited in claim 1, wherein said one of the remote computers is programmed to additionally transmit its identification data to said central computer.

5. The golf course wireless network as recited in claim 1, further comprising additional signal receivers, each of which is connected to one of the remote computers.

6. The golf course wireless network as recited in claim 1, wherein the remote computers have a fixed greenside location.

7. The golf course wireless network as recited in claim 6, wherein each hole on the golf course has at least one remote computer located greenside.

8. The golf course wireless network as recited in claim 1, wherein the remote computers are carried on golf carts.

9. The golf course wireless network as recited in claim 8, wherein each golfing group has at least one golf cart with a remote computer.

10. The golf course wireless network as recited in claim 1, wherein each of the central computer and the remote computers has a wireless data link connected thereto, through which data is transmitted and received.

11. A golf course wireless network, comprising:
a central computer; and
a plurality of remote computers located on different holes of the golf course, said central computer and remote computers forming a wireless network,
wherein said remote computers transmit hole location data, time stamp data, and remote computer identification data to the central computer through the wireless network.

12. The golf course wireless network as recited in claim 11, wherein the remote computers have a fixed greenside location.

13. The golf course wireless network as recited in claim 12, wherein the wireless network comprises a peer-to-peer wireless network.

14. The golf course wireless network as recited in claim 13, wherein a first remote computer communicates directly with the central computer and a second remote computer communicates with the central computer indirectly through said first remote computer.

15. A method of monitoring events at remote locations of a golf course and transmitting event data to a central location of the golf course, said method comprising the steps of:
(a) from time to time, sensing an event at a first remote location with a first remote unit and at a second remote location with a second remote unit;
(b) transmitting data relating to the event at the first remote location from the first remote unit to a central unit at the central location;
(c) transmitting data relating to the event at the second remote location from the second remote unit to the first remote unit; and
(d) transmitting data relating to the event at the second remote location from the first remote unit to the central unit.

16. The method as recited in claim 15, wherein the remote locations are greens of the golf course, and the first and second remote units are located greenside.

17. The method as recited in claim 16, wherein the step of sensing includes the steps of sensing when a flag stick has been moved, transmitting a signal when the flag stick has been moved, and receiving said signal at a remote unit at the remote location.

18. The method as recited in claim 15, wherein the remote locations are greens of the golf course, and the first and second remote units are carried in golf carts.

19. The method as recited in claim 18, wherein the first remote unit senses the event at the first remote location when the first remote unit becomes positioned alongside the first remote location and the second remote unit senses the event at the second remote location when the second remote unit becomes positioned alongside the second remote location.

20. The method as recited in claim 15, further comprising the step of receiving and processing said transmitted data and displaying information representative of the events.
